(19) United States
(12) Patent Application Publication
(10) Pub. No.: US 2009/0138310 A1
(43) Pub. Date: May 28, 2009

(54) METHOD FOR ACCESSING VETERINARY HEALTH CARE INFORMATION AND FINANCING VETERINARY HEALTH CARE SERVICES

(76) Inventor: Thomas Beall, Spencer, IA (US)

Correspondence Address: ZARLEY LAW FIRM P.L.C., CAPITAL SQUARE, 400 LOCUST, SUITE 200, DES MOINES, IA, 50309-2350, US

(21) Appl. No.: 11/944,692

(22) Filed: Nov. 26, 2007

(51) Int. Cl. G06Q 50/00; G06F 17/30; G06Q 10/00; G06Q 30/00; G06Q 40/00

(52) U.S. Cl. 705/8; 705/1; 705/26; 705/39

(57) ABSTRACT

A method for accessing veterinary health care information via an Internet website, wherein subscribers to the website are able to search and review a library of veterinary health care information, ask questions of a qualified veterinarian, schedule one-on-one consultations as well as office visits with a qualified veterinarian, and purchase veterinary health care products. Using this method, subscribers may also finance veterinary health care products and services using a pet health savings account.

### BACKGROUND OF THE INVENTION

Pet owners often have a need for information regarding the health of their pets. Circumstances underlying this need range from curiosity about routine health issues to more pressing situations such as when acute illness or injury is suspected. While there is no substitute for a thorough physical examination by, and personal consultation with, a qualified veterinarian, there are countless situations in which pet owners are either unwilling or unable to obtain this treatment.

In addition, on average, a pet owner might pay $200-$400 a year per pet for conventional animal health insurance. As with typical human health insurance plans, there are deductibles for each office visit. Many popular, widely available policies cover only a pre-determined amount for treating each condition diagnosed by a veterinarian, irrespective of where the policyholder resides or whether there are local or regional cost variances. In addition, these policies frequently do not cover pre-existing conditions, congenital, or breed specific problems (e.g., hip dysplasia or cranial cruciate rupture in Labrador retrievers). Less than 1% of pets are covered by pet health insurance in the United States, in part because such policies are not cost effective for pet owners.

Every day in small animal practices and veterinary hospitals across the country, finances dictate life and death situations. Technology continues to advance veterinary healthcare, in turn allowing pets to live happier, healthier, and longer lives. Unfortunately, veterinary medicine does not have the governmental support or subsidies available for human care. As a result, paying for advanced veterinary healthcare is the sole responsibility of the pet owner. Pet health savings accounts are a viable way of easing this responsibility, without paying any premiums to an insurer that might be lost if the coverage is not needed or if the pet dies.

An objective of the invention is to provide a method for accessing veterinary health care information via an Internet website, wherein subscribers to the website are able to search and review a library of veterinary health care information.

Another objective is to provide a method by which questions may be asked of a qualified veterinarian, and by which consultations and office visits may be scheduled with a qualified veterinarian.

Yet another objective is to provide a method by which veterinary health care products may be purchased.

Still another objective is to provide a method by which veterinary health care products and services may be financed using a pet health savings account.

These and other objectives will be apparent to one skilled in the art based on the following written description.

### BRIEF SUMMARY OF THE INVENTION

A method of accessing veterinary health care information is provided in which pet owners can readily obtain valuable information without having to locate a veterinarian or schedule an appointment. Using an Internet website, subscribers can research common veterinary topics, direct an individualized question to a veterinarian, schedule live consultations as well as office visits with a veterinarian, and purchase veterinary health care products. Subscribers may also finance all or part of their veterinary health care products and services using a pet health savings account opened online using the website.

### BRIEF DESCRIPTION OF THE DRAWINGS

FIG. 1 is a schematic view of the environment of a method for accessing veterinary health care information.

FIG. 2 is a flow diagram representing the set-up mode sub-unit of a method for accessing veterinary health care information.

FIG. 3 is a flow diagram representing the question-and-answer mode sub-unit of a method for accessing veterinary health care information.

FIG. 4 is a flow diagram representing the search mode sub-unit of a method for accessing veterinary health care information.

FIG. 5 is a flow diagram representing the pet health savings account sub-unit of a method for accessing veterinary health care information.

### DETAILED DESCRIPTION OF THE PREFERRED EMBODIMENT

The embodiments discussed herein are merely illustrative of specific manners in which to make and use the invention and are not to be interpreted as limiting the scope of the instant invention.

While the invention has been described with a certain degree of particularity, it is to be noted that many modifications may be made in the details of the invention's construction and the arrangement of its components without departing from the spirit and scope of this disclosure. It is understood that the invention is not limited to the embodiments set forth herein for purposes of exemplification.

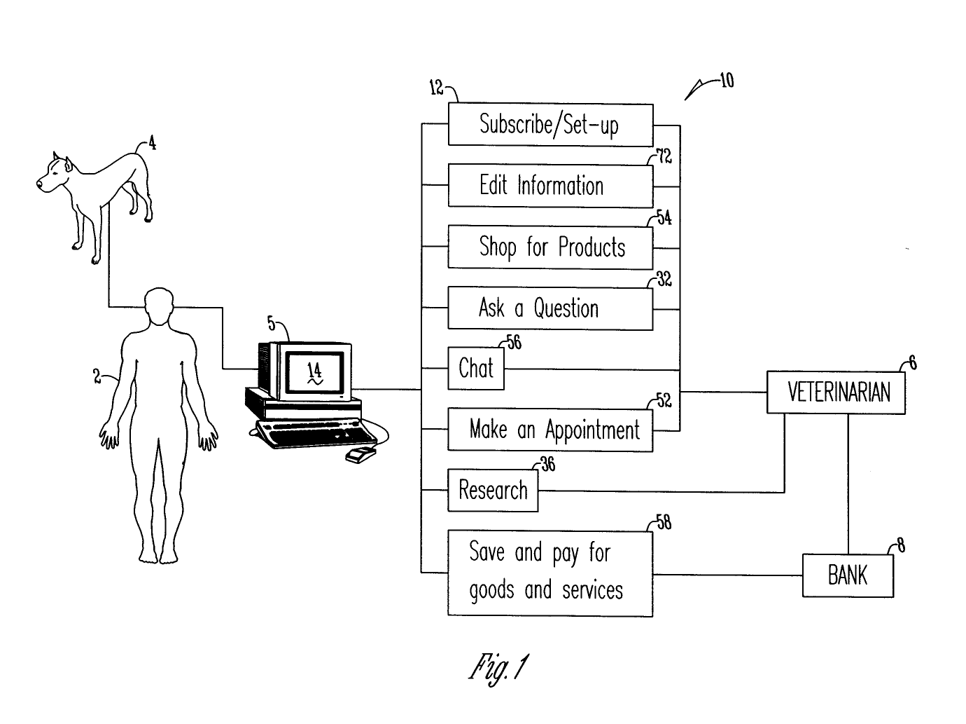

Referring to the schematic representation of FIG. 1, a user 2 who owns one or more pets 4, accesses an Internet web-site 10 by any conventional means, such as a computer terminal 5. Web-site 10 is hosted by or on behalf of one or more participating veterinarians 6. “Veterinarian” herein is not intended to be limiting and may refer to any qualified veterinary health care provider, including licensed veterinarians as well as veterinary clinics and hospitals. Bank 8 is generally a conventional financial institution such as a bank, credit union or savings and loan.

Upon accessing web-site 10, the user is presented with welcome screen 14. If the user is accessing web-site 10 for the first time, the user may utilize set-up mode 12, while existing subscribers may edit their subscription or user information via edit user info mode 72. Users may proceed directly to other features accessible via welcome screen 14.

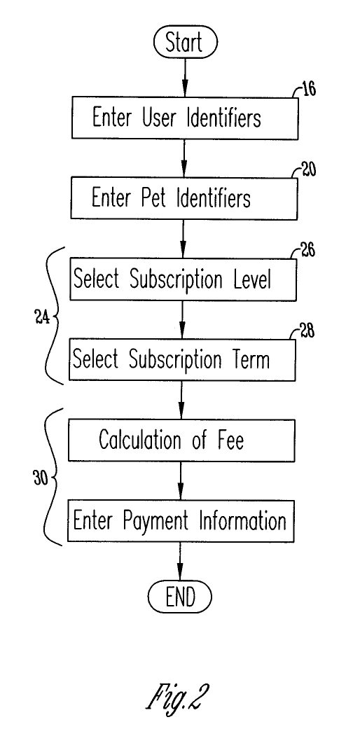

Turning to FIG. 2, user identification module 16 of set-up mode 12 permits a user to input one or more user identifiers. User identifiers may include, without limitation, the user's name, physical address, home telephone number, cellular telephone number, business telephone number, fax number and e-mail address.

Pet identification module 20 of set-up mode 12 permits a user to input or enter one or more pet identifiers. Pet identifiers may include, without limitation, name, species, breed, sex, birth date, weight and a photograph. Photographs, such as photograph data files in conventional digital formats such as “.jpg”, may be uploaded to web-site 10 using means that are well known in the art.

Subscription module 24 of set-up mode 12 permits a user to select a subscription level 26 and a term 28. Subscription level 26 is typically selected from a plurality of tiered subscriptions, each tier entitling its respective subscribers to varying levels of access or frequency of access to veterinary health care information using web-site 10. In an exemplary embodiment, three tiered subscription levels 26 are provided (“budget”, “basic” and “premium”, as characterized in Table 1.

TABLE 1

| | Subscription Tier | | |
|---|---|---|---|
| | Budget | Basic | Premium |
| Individualized Questions | 1/month | 2/month | 4/month |
| Online Searching of Library | unlimited | unlimited | unlimited |
| Monthly Newsletter | included | included | included |
| Discount on Products | n/a | included | included |
| Participation in Pet Health | n/a | included | included |
| Savings Account | | | |
| Online or Telephone | available | available | 1 every 3 |
| Consultations | for fee | for fee | months |
| | | | included |

In addition to subscription level 26, the user is asked to select a subscription term 28. Term 28 is generally quantified in terms of a number of months or years. The final module of set-up mode 12 is payment module 30. Depending on the rate associated with subscription level 26 and the term of subscription 28 desired, payment module 30 calculates a total subscription fee and payment is collected using any number of payment methods known in the art.

Referring back to FIG. 1, upon completion of set-up mode 12, the user is directed to welcome screen 14. Welcome screen 14 is a gateway to the features of web-site 10, herein designated as “modes”, and permits the user to utilize the various services provided. “Module” as used herein refers to a sub-component of the various modes.

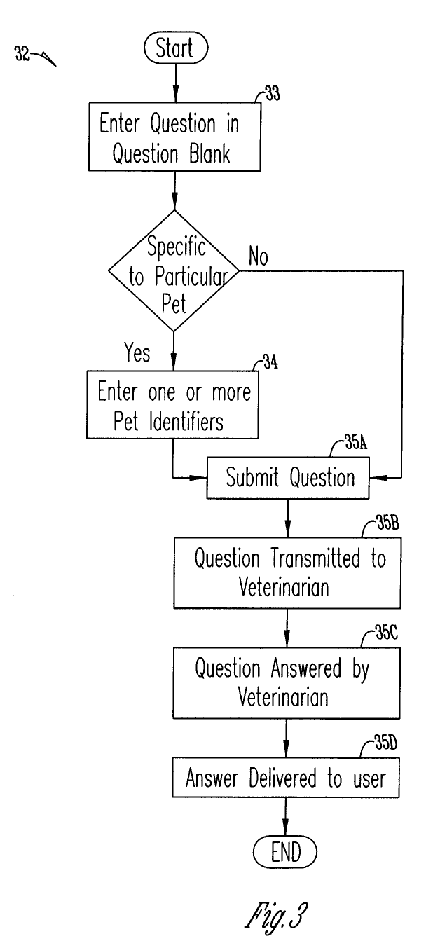

Ask-a-question mode 32 permits a user to compose a custom, user-specified question to be responded to individually by a qualified veterinary health care provider such as a licensed veterinarian. Now turning to FIG. 3, ask-a-question mode 32 comprises question blank module 33 and pet identification module 34. The user's question is entered in the conventional manner, e.g. clicking on the field and typing, into question blank 33. Optionally, the user may utilize pet identification module 34, which is linked to pet identifiers of pet identification module 20, to identify the pet to which the user's question in blank 33 pertains. The ask-a-question mode then submits the question at block 35a wherein the question is transmitted to the veterinarian at block 35b. Then the question is answered by the veterinarian at block 35c and the answer is delivered to the user at block 35d.

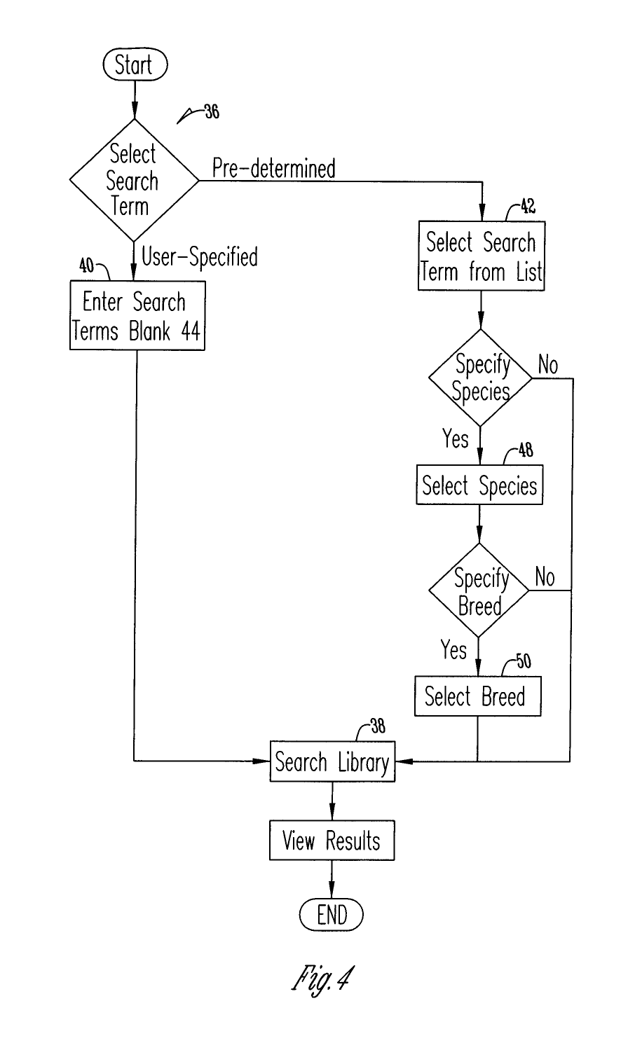

Returning to FIG. 1, welcome screen 14 further comprises search mode 36. As depicted in FIG. 4, search mode 36 permits a user to search and review library 38. Library 38 comprises commonly asked questions and answers in the field of veterinary medicine and health care. Library 38 further comprises questions and answers developed by users via ask-a-question mode 32. It will be appreciated that the scope of library 38 is not static but is adapted to grow as more users utilize ask-a-question mode 32, in addition to growth occasioned through periodic updates and expansion. Library 38 may be maintained by or on behalf of veterinarian 6.

Library 38 is cataloged using a number of cataloging techniques known in the art, including but not limited to being cataloged by a plurality of search terms. For example, a question and answer relating to the eating habits of poodles may be cataloged under a number of searchable terms such as ‘dog’, ‘food’, ‘eat’, ‘eating’, ‘diet’ and ‘poodle’.

Search mode 36 comprises a user-specified search term module 40 and a pre-determined search term module 42. User-specified search term module 40 enables the user to input one or more custom search terms in search term blank 44. Said one or more custom search terms are then searched against library 38, and the results are presented for viewing by the user.

Pre-determined search term module 42 enables the user to select one or more search terms from a predetermined list. The predetermined list may include species identification 48 and breed identification 50, of which one or both may be selected. For example, the user may utilize pre-determined search term module 42 to search library 38 for all questions and answers related to dogs (e.g., by selecting ‘dog’ from species identification 48 and not selecting breed identification 50), or all questions and answers related to Siamese cats (selecting ‘cat’ from species identification 48 and ‘Siamese’ from breed identification 50).

As with user-specified search term module 40, the search results obtained from pre-determined search term module 42 are presented for viewing by the user.

Referring back to FIG. 1, welcome screen 14 further comprises appointment setting mode 52, whereby the user may request that an office appointment be scheduled with a qualified veterinary health care provider such as a licensed veterinarian. The appointment may be scheduled based on criteria such as provider availability, geographic proximity, or expertise, depending on the circumstances.

Still referring to FIG. 1, welcome screen 14 comprises shopping mode 54, whereby the user may peruse, shop and purchase veterinary health care products. Shopping mode 54 may be modeled after any of a number of Internet shopping sites that are well known in the art. Depending on the user's subscription level 26, or any ongoing promotions, the user may be entitled to a discount on goods purchased using shopping mode 54. Veterinarian 6 may sell products directly, and the goods may come from one or more third-party vendors as well.

Also found at welcome screen 14 is consultation mode 56. Consultation mode 56 enables the user to schedule a live, real-time dialogue with a qualified veterinary health care provider such as a licensed veterinarian. This dialogue may be either telephone or may be online over the Internet (i.e., chat), in any conventional manner. As with appointment setting mode 52, consultation mode 56 can be utilized to match up the user with a provider based on such criteria as availability or expertise. It will be appreciated that geographic proximity is not as important a consideration for consultations as with office visits, save for potential time zone differences. Again, depending on the user's subscription level 26, the user may be entitled a consultation without charge utilizing consultation mode 56.

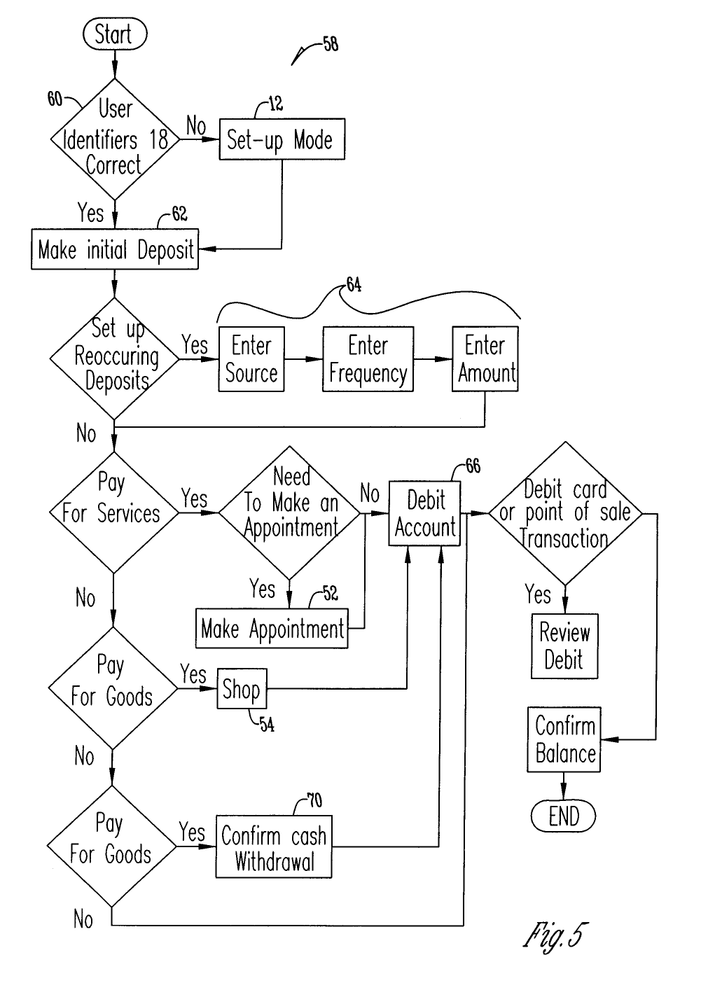

Welcome screen 14 also comprises pet health savings account mode 58. Turning to FIG. 5, pet health savings account mode 58 comprises information confirmation module 60, initial deposit module 62, recurring deposit module 64 and debit module 66.

The user is able to utilize pet health savings account mode 58 to establish online over the Internet a pet health savings account at a financial institution (e.g., bank 8 in FIG. 1). Alternatively, such an account could be opened in a manner not over the Internet.

The pet health savings account may be an interest bearing account, and may feature a number of financial incentives to the user. For example, the user may receive a match up to a predetermined proportion or dollar amount for the initial and subsequent deposits, this match being funded by one or more veterinary health care providers. Other incentives include cash rebates on veterinary health care products and services purchased, as well as discounted rates on such products and services.

Still referring to FIG. 5, information confirmation module 60 of pet health savings account mode 58 is linked to user identification module 16 and user identifiers of set-up mode 12. The user is permitted to confirm that this information is correct. Initial deposit module 62 enables the user to make arrangements for an initial deposit into the pet health savings account. This initial deposit may be made in any amount, and in any conventional manner known in the art, including electronic funds transfers, wire transfers and cash deposits.

The user then has the option to set up future or recurring deposits using recurring deposit module 64. Deposits into the account may be made periodically, and future deposits of any amount may be made in any conventional manner known in the art. For example, such deposits could result from electronic funds transfers (EFTs), cash deposits, or payroll deductions.

Still referring to FIG. 5, debits from the account are handled through debit module 66 of pet health savings account mode 58. Debit module 66 is linked to appointment setting mode 52 such that some portion of or all of the costs associated with the office appointment may be deducted from the account. Debit module 66 is further linked to shopping mode 54 such that purchases made therein may be paid for using funds deducted from the account. Point of sale transactions and debits, as well as the aforementioned financial incentives, can be universally available or limited to a predetermined population of providers and/or merchants. Such transactions can be reviewed or tracked using web-site 10.

In one embodiment, illustrated schematically at FIG. 5, the user may obtain a funds access card or a debit card 68 that is linked to the account. Alternatively, debit card 68 may bear a likeness of one or more of the user's pets. For example, a photograph submitted via pet identification module 20 of set-up mode 12 could be printed onto card 68. Funds access card 68 is preferably a debit card that is suitable for use in automated teller machine (ATM). Cash withdrawals 70 from the account in a manner other than ATM may also be available.

In the event of the death of the user's pet or pets, the balance of the user's account less any pending transactions is available for disbursement to the user. Alternatively, the user may link the account to one or more additional or surviving pets.

Referring back to FIG. 1, the user may edit his or her user identifiers or pet identifiers, or change his or her subscription level 26 and term 28, or change how his or her subscription is paid 30, from welcome screen 14 by utilizing edit user info mode 72, which directs the user into set-up mode 12.

Whereas, the present invention has been described in relation to the drawings attached hereto, it should be understood that other and further modifications, apart from those shown or suggested herein, may be made within the spirit and scope of this invention.

What is claimed is:

1. A method for accessing veterinary health care information via the Internet comprising the steps of:
accessing an Internet website having a library of veterinary health care information and a plurality of modes for accessing the veterinary health care information;
selecting a desired mode of health care information;
inputting information related to the desired mode; and
displaying veterinary health care information based upon the selected desired mode and inputted information.

2. The method of claim 1 wherein the desired mode is a set-up mode that permits a user to input one or more user identifiers.

3. The method of claim 2 wherein the user identifiers includes at least one of user's name, physical address, home telephone number, cellular telephone number, business telephone number, fax number or e-mail address.

4. The method of claim 2 wherein the set-up mode has an identification module to permit a user to input or enter one or more pet identifiers.

5. The method of claim 4 wherein the pet identifiers include at least one of, name, species, breed, sex, birth date, weight and a photograph.

6. The method of claim 2 wherein the set-up mode has a subscription module that permits a user to select a subscription level and a term.

7. The method of claim 6 wherein the subscription level is selected from a plurality of tiered subscriptions.

8. The method of claim 6 wherein the subscription term is quantified in terms of a number of months.

9. The method of claim 2 wherein the set-up mode has a payment module that calculates a total subscription fee.

10. The method of claim 1 wherein the desired mode is an ask-a-question mode that permits a user to compose a custom, user-specified question to be responded to individually by a qualified veterinary health care provider.

11. The method of claim 10 wherein the ask-a-question mode has a question blank module and pet identification module.

12. The method of claim 1 wherein the desired mode is a search mode that permits a user to search and review a library.

13. The method of claim 12 wherein the library comprises commonly asked questions and answers in the field of veterinary medicine and health care.

14. The method of claim 12 wherein the search mode comprises a user-specified search term module and a pre-determined search term module wherein the user-specified search term module enables the user to input one or more custom search terms in a search term blank and the pre-determined search term module enables the user to select one or more search terms from a predetermined list.

15. The method of claim 1 wherein the desired mode is an appointment setting mode whereby the user requests an office appointment.

16. The method of claim 1 wherein the desired mode is a shopping mode whereby the user shops for veterinary health care products.

17. The method of claim 1 wherein the desired mode is a consultation mode that enables the user to schedule a real-time dialogue with a qualified veterinary health care provider.

18. The method of claim 1 wherein the desired mode is a pet health savings account mode that comprises information confirmation module, initial deposit module, recurring deposit module and debit module such that the user is able to establish online over the Internet a pet health savings account at a financial institution.

19. The method of claim 18 wherein the information confirmation module is linked to a user identification module and a user identifier of a set-up mode; wherein the initial deposit module enables the user to make arrangements for an initial deposit into the pet health savings account; wherein the recurring deposit module sets up future deposits; and wherein the debit module is deducts money from an account.
